(19) United States
(12) Patent Application Publication
(10) Pub. No.: US 2017/0017052 A1
(43) Pub. Date: Jan. 19, 2017

(54) ACTIVE OPTICAL CABLE MODULE FOR CABLE SYSTEM

(71) Applicant: TYCO ELECTRONICS CORPORATION, Berwyn, PA (US)

(72) Inventor: BRIAN PATRICK COSTELLO, Scotts Valley, CA (US)

(21) Appl. No.: 14/801,272

(22) Filed: Jul. 16, 2015

(51) Int. Cl. G02B 6/42; G02B 6/44; G02B 6/38; H01R 12/70

(52) U.S. Cl. CPC G02B 6/4284; H01R 12/7076; G02B 6/428; G02B 6/4292; G02B 6/421; G02B 6/4267; G02B 6/4453; G02B 6/3897

(57) ABSTRACT

A module having first and second ends, and comprising at least one circuit board extending from the first end to the second end; at least one electrical connector at the first end, the at least one electrical connector being electrically connected to the circuit board, the electrical connector having a form factor of a standard electrical connector; at least one optical connector at the second end; a plurality of optical electrical devices (OEDs) disposed on the circuit board, wherein the OEDs are connected electrically to the at least one electrical connector through the circuit board, and wherein the OEDs are connected optically to at least one optical connector.

### FIELD OF INVENTION

The subject matter herein relates generally to active cable assemblies for use in cable systems having mating planes.

### BACKGROUND

Some electrical systems, such as network switches and computer servers with switching capability, include receptacle connectors that are oriented orthogonally on mating planes of a midplane in a cross-connect application. Switch cards may be connected on one side of the midplane and line cards may be connected on the other side of the midplane. Generally, the line cards bring data from external sources into the system, while the switch cards contain circuitry that may switch data from one line card to another.

The line card and switch card are joined through header connectors that are mounted on mating planes of the midplane board. Typically, traces are provided on the top and bottom sides and/or the internal layers of the midplane board to route the signals between the header connectors.

Signal loss is inherent in a conductive trace through printed circuit board. As the number of card connections increases, more traces are required in the midplane. The increased density of traces and the length of the traces in the midplane introduce more and more signal loss in the midplane, particularly at higher signal speeds. Signal loss problems may be addressed by keeping traces in the midplane as short as possible. Connectors are sometimes oriented orthogonally on both sides of a midplane. With orthogonal connectors, the number and lengths of traces in the midplane may be reduced, thereby reducing trace losses in the midplane.

Another approach for reducing trace losses is to eliminate the PCB traces, and use cable instead. Connecting copper cables between connectors is known to reduce losses and allow for higher data rates. In the future, however, large scale systems may not be able to utilize cable for high speed interfaces due to, for example, performance, physical space, and routabilty of cables.

Applicants recognize that fiber optical cables are an attractive alternative to copper cables. For example, fiber optic cables take up less physical space, are lighter in weight, are immune from Electro Magnetic Interference, can travel farther distances, and are capable of significantly higher speeds when multi-level signaling and/or wave division multiplexing are used.

Applicants also recognize the ability to replace existing copper cable trays with fiber trays of the same size would enable customers to retrofit existing systems with minimal obstacles in the upgrade path. More specifically, if the cable trays could receive the same switch and line cards by using the same type of header connectors, for example the STRADA Whisper® sold by TE Connectivity, then the midplane could be replaced without disturbing the cabinets and scrapping the line and switch cards. The present invention fulfills this need among others.

### SUMMARY OF INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention relates to an active optical cable (AOC) module on a midplane connector system to transmit signals between switch and line cards optically, rather than electrically. More specifically, in one embodiment, the mating electrical interface of the AOC module is essentially the same as existing or standard header connectors, allowing it to fully interface with existing line and switch cards. For example, in one embodiment, the AOC module is configured to mate to standard and orthogonal Whisper R/A Receptacles. Thus, the AOC module of the present invention facilitates the retrofit of a copper-based midplane connector system with fiber optics without disturbing the panels or scrapping the line and switch cards

Accordingly, one aspect of the invention is an AOC module comprising standard electrical interfaces for interfacing with the electrical interfaces of pre-existing or standard line and switch cards. In one embodiment, the module has first and second ends, and comprises: (a) at least one circuit board extending from the first end to the second end; (b) at least one electrical connector at the first end, the at least one electrical connector being electrically connected to the circuit board, the electrical connector having a form factor of a standard electrical connector; (c) at least one optical connector at the second end; and (d) a plurality of optical electrical devices (OEDs) disposed on the circuit board, wherein the OEDs are connected electrically to at least one electrical connector through the circuit board, and wherein the OEDs are connected optically to at least one optical connector.

Another aspect of the invention is a midplane cable tray in which the different electrical connectors for interfacing with the line and switch cards are interconnected with optical fibers via the AOC modules to facilitate high speed connections. In one embodiment, the midplane cable tray comprises: (a) a tray having a mating plane; (b) a plurality of modules arranged along the mating plane, each module having first and second ends, and comprising at least: (i) at least one circuit board extending from the first end to the second end; (ii) at least one electrical connector at the first end, the at least one electrical connector being electrically connected to the circuit board, the electrical connector having a form factor of a standard electrical connector; (iii) at least one optical connector at the second end; and (iv) a plurality of optical electrical devices (OEDs) disposed on the circuit board, wherein the OEDs are connected electrically to the at least one electrical connector through the circuit board, and wherein the OEDs are connected optically to at least one the optical connector; and (c) optical fibers, each fiber terminated at both ends with first and second optical connectors, the first optical connector connected to the at least one optical connector of a first module of the plurality of modules, and the second optical connector connected to the at least one optical connector of a second module of the plurality of modules.

Yet another aspect of the invention is a cable system comprising an assembly of cable trays as described above. In one embodiment, a midplane connector assembly comprises: (a) a plurality of trays, each tray having a mating plane and comprising at least: (i) a plurality of modules arranged along the mating plane, each module having a first and second end, and comprising at least: at least one circuit board extending from the first end to the second end; at least one electrical connector at the first end, the at least one electrical connector being electrically connected to the circuit board, the electrical connector having a form factor of a standard electrical connector; at least one optical connector at the second end; and a plurality of optical electrical devices (OEDs) disposed on the circuit board, wherein the OEDs are connected electrically to the at least one electrical connector through the circuit board, and wherein the OEDs are connected optically to at least one optical connector; (ii) optical fibers, each fiber terminated at both ends with first and second optical connectors, the first optical connector connected to the at least one optical connector of a first module of the plurality of modules, and the second optical connector connected to the at least one optical connector of a second module of the plurality of modules.

### BRIEF DESCRIPTION OF FIGS.

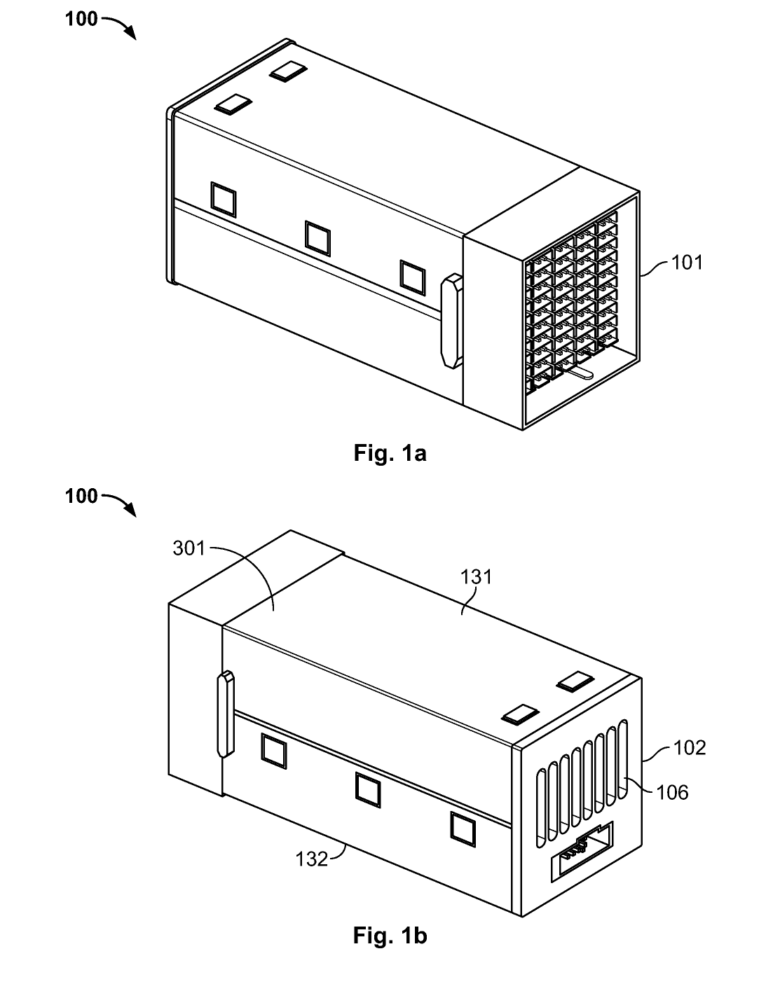

FIGS. 1a and 1b show one embodiment of the active optical cable module from the perspective of the first and second ends respectively.

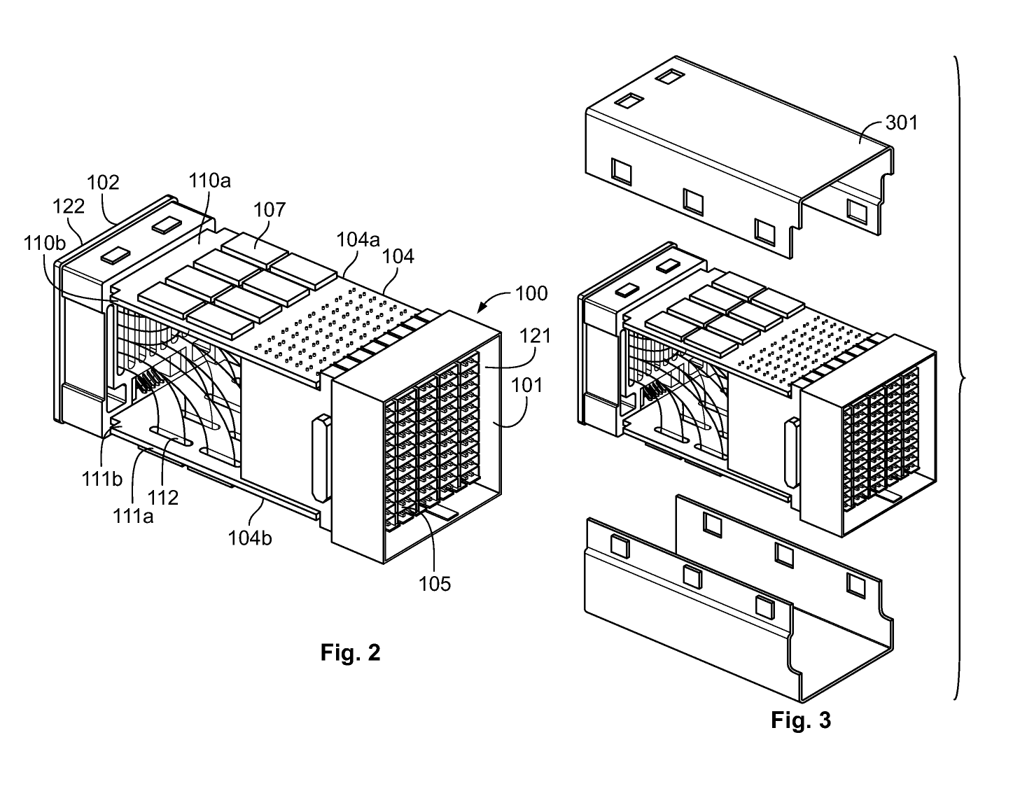

FIG. 2 shows the AOC module of FIG. 1a with the housing removed.

FIG. 3 shows an exploded view of the AOC module of FIG. 1a.

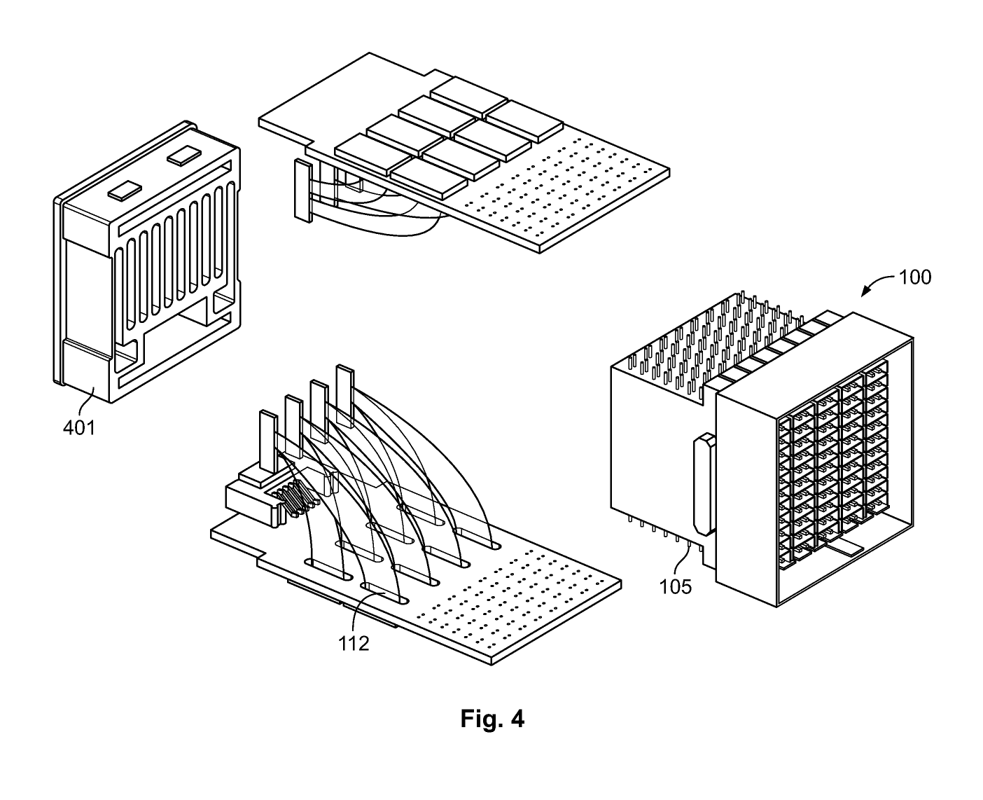

FIG. 4 shows an exploded view of the AOC module of FIG. 2 with the first and second circuit boards separated from the electrical and optical connectors.

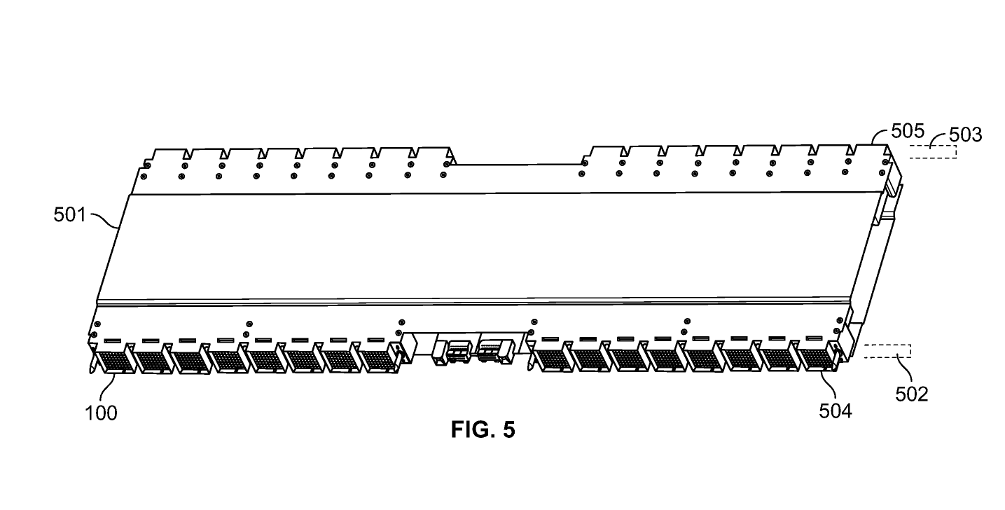

FIG. 5 shows a plurality AOC modules of FIG. 1a integrated into a cable tray.

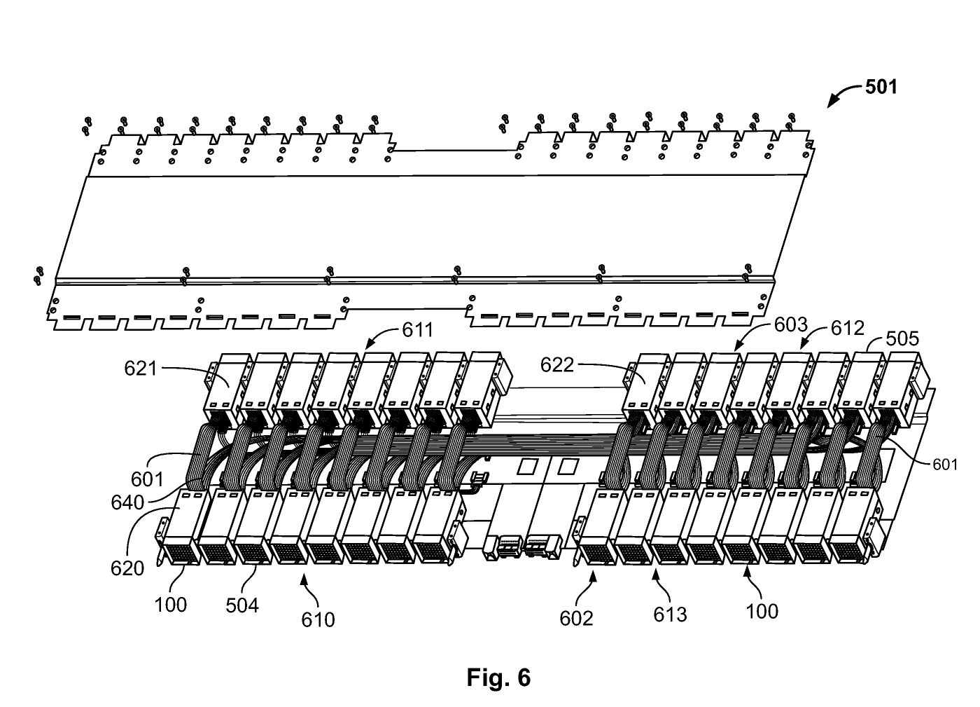

FIG. 6 shows an exploded view of the cable tray of FIG. 5 with a cover removed.

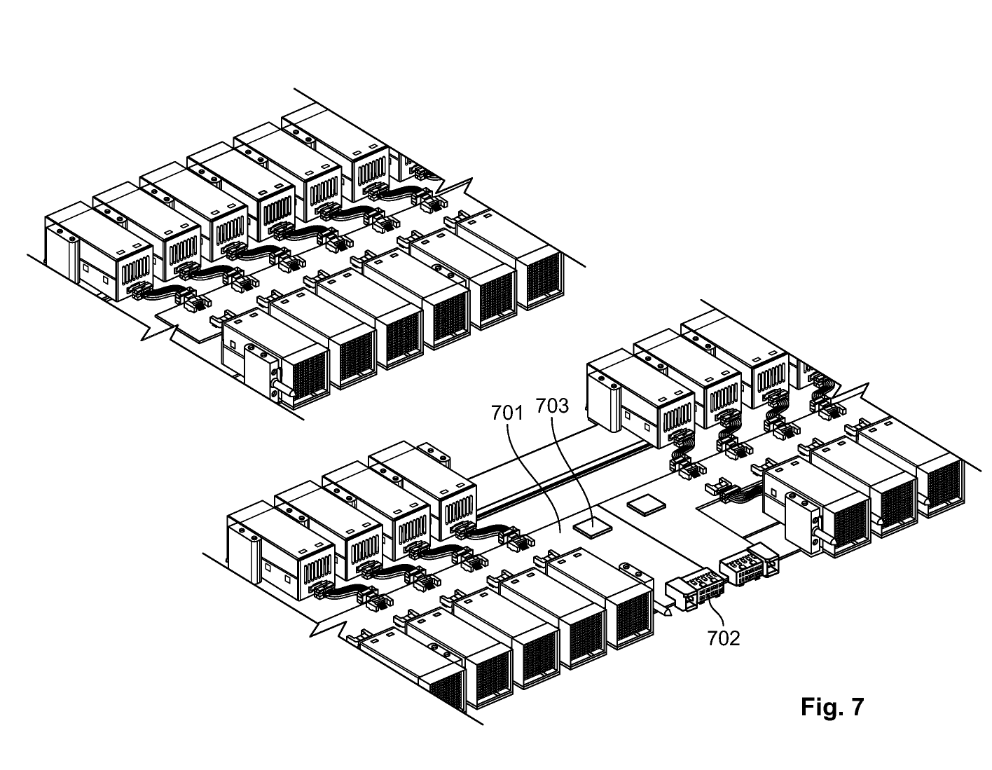

FIG. 7 shows a portion of the cable tray of FIG. 5 with the optical fibers removed to reveal the circuit board inter-connecting the various AOC modules for lower speed AOC control signals and power.

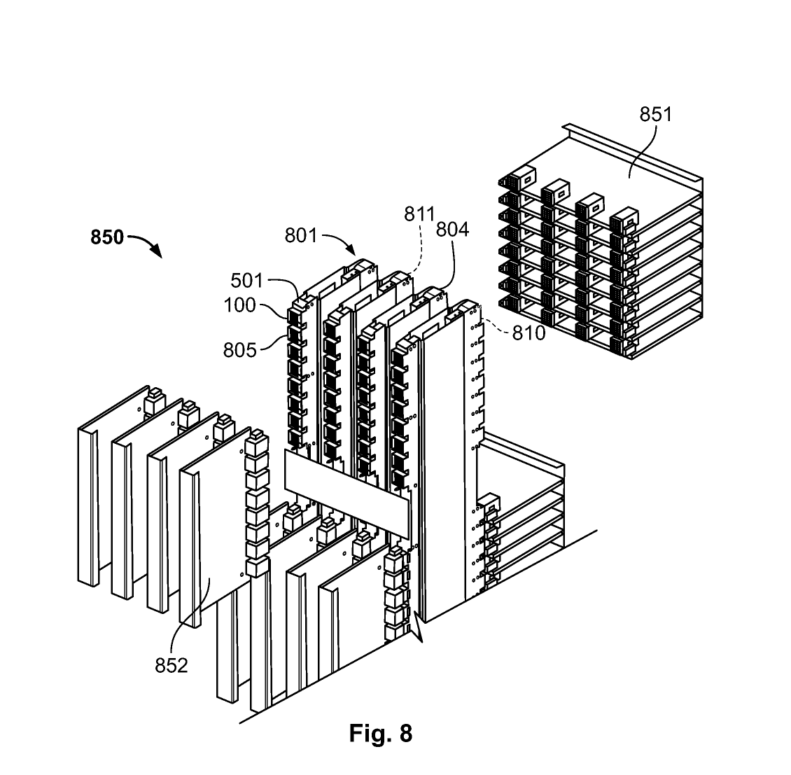

FIG. 8 shows an exploded view of a cable system comprising a cable mid-plane assembly having a number of cable trays of FIG. 6, with horizontal line cards and vertical switch cards.

### DETAILED DESCRIPTION

Referring to FIGS. 1-4, one embodiment of the active optical cable (AOC) module 100 of the present invention is shown. The module 100 has first and second ends 101, 102 as shown in FIGS. 1a and 1b, respectively. Referring to the embodiment of FIGS. 2 and 3, the module 100 comprises at least one circuit board 104 extending from the first end 101 to the second end 102. At the first end 101 is at least one electrical connector 105 which is electrically connected to the circuit board 104. In one embodiment, the electrical connector 105 has a form factor of a standard electrical header connector used in midplane connector systems. At the second end 102 is at least one optical connector 106 (see FIG. 1b). A plurality of optical electrical devices (OEDs) 107 are disposed on the circuit board 104 as shown in FIGS. 2 and 3. The OEDs are connected electrically to the electrical connector through the circuit board and are connected optically to the optical connector. Each of these elements in considered below in greater detail and with respect to selected alternative embodiments.

An important aspect of the present invention is the ability to retrofit copper-based systems with optical fibers using the AOC module of the present invention as the interface between the existing electrical cards and optical fibers. Accordingly, in one embodiment, the AOC module comprises an electrical connector 105 which is based upon a standard electrical header connector used in mid-plane connector systems. Such standard header connectors are well known and commercially available. Suitable connectors include, for example, the STRADA Whisper® standard and orthogonal connectors, Z-Pack Tinman, Z-Pack HM-ZD, & Z-Pack Slim UHD. Additionally, the electrical connector 105 may comprise a single connector, or it may comprise an array of connectors. Likewise, the electrical connector 105 may comprise any number of electrical conductors. Referring to the embodiment of FIGS. 1-4, the electrical connector 105 is a STRADA Whisper® header connector.

The optical connector 106 may be any standard or custom optical connector. Suitable connectors include, for example, MPO, MPX, MU, MTRJ, LC, SC, etc. Additionally, the optical connector 106 may comprise a single connector, or it may comprise an array of connectors. Likewise, the optical connector 106 may comprise any number of optical conductors. Referring to the embodiment of FIGS. 1-4, the optical connector 106 comprises an array of MPO connectors. In this particular embodiment, the array of connectors 106 is held in place by a rear housing 401 (see FIG. 4) which also receives and holds an end of the circuit board(s) 104. The rear housing 401 in this embodiment is die cast.

In one embodiment, the electrical connector(s) 105 defines a first face 121 and the optical connector(s) defines a second face 122. As shown in the embodiment of FIG. 2, the first and second faces 121, 122 are parallel and are spaced apart by the circuit board(s) 104 as shown. It should be understood, however, that other embodiments are possible. For example, rather than the first and second face being parallel, they could be orthogonal or angled with respect to one another.

The number of circuit boards used in the AOC module 100 depends upon the application. For example, in the embodiment shown in FIG. 2, two circuit board(s), 104a, 104b are used. The circuit boards 104a, 104b extend in parallel between the electrical connector 105 and the optical connector 106. Although circuit boards 104a and 104b are shown parallel, it should be understood that other embodiments are possible. For example, rather than being parallel, these circuit boards may be orthogonal. Furthermore, any number of circuit boards may be used. For example, rather than just two circuit boards, an additional two circuit boards could be disposed adjacent sides to the first and second circuit boards 104a and 104b. Alternatively, multiple circuit boards may be layer in parallel. Still other embodiments will be obvious to those of skill in light of this disclosure.

Yet another embodiment of the AOC module 100 eliminates the use of the circuit board altogether, and, instead, interfaces the electrical connector directly with the OEDs, which, in turn are optically coupled to the optical connector 106. In yet another embodiment, the OEDs are directly interfaced with the electrical connector. In this respect, in one embodiment, the OEDs may not be optically coupled to the optical connector 106, but rather may be optically linked directly with other AOC modules in the midplane cable tray without the use of an intermediate optical connector 106. Still other embodiments will be obvious to those skilled in the art in light of this disclosure.

In the embodiment of FIG. 2, each of the circuit boards 104a, 104b has an outer surface 110a, 111a which faces outward toward the first and second sides 131, 132 (See FIG. 1) of the AOC module 100, and an inner surface 110b, 111b, which faces inwardly. In one embodiment, the inner surfaces 110b, 111b face each other. In the embodiment shown in FIG. 2, the OEDs 107 are disposed on the outer surface 110a, 111a of the first and second circuit boards 104a, 104b. In this embodiment, the optical connection between the OEDs 107 and the optical connector 106 is facilitated by optical fibers, which extend from the bottom surface of the OEDs 107 through openings 112 in the circuit boards 104a, 104b. Such a configuration facilitates the optical fibers being contained within the interior of the module as shown, as opposed to being on the module's periphery where they may be snagged or otherwise damaged. Additionally, by having the OEDs on the periphery of the AOC module 100 they can more readily dissipate heat as described in greater detail below.

In one embodiment, a housing 301, as shown in FIGS. 1 and 3, is configured to fit snugly around the OEDs 107 to facilitate heat dissipation. More specifically, in one embodiment, the housing 301, which preferably, although not necessarily, comprises a heat conductive material on the first and second sides 131, 132, which is in thermal communication with the OEDs on the outer surfaces 110a, 111a such that the housing 301 acts as a heat sink to dissipate heat away from the OEDs 107. Thermal communication in this context means either contacting the OEDs or otherwise be capable of transferring heat from the OEDs to ambient.

The AOC module 100 is configured to attach or be mounted to existing backplane, mid-plane or other assemblies having at least one mating plane. For example, referring to FIG. 5, the AOC module 100 is incorporated into a cable tray 501. In the embodiment shown in FIG. 5, the cable tray 501 is a STRADA Whisper 12 differential pair per column by 8 column system, which, at the time of this application is a well-known, midplane connection system. In this particular embodiment, the cable tray comprises two mating planes 502, 503, on opposite sides 504, 505 of the tray respectively. It should be understood, however, that a tray having just one mating plane, a tray having more than two mating planes, or a tray having orthogonal/angled matting planes is within the scope of the invention.

Referring to FIG. 6, a cover of the cable tray 501 is removed revealing a plurality of AOC modules 100 interconnected to each other via optical fibers 601. The interconnection of the AOC modules can vary according to the application. In this particular tray assembly, the AOC modules are divided into four groups 610, 611, 612 and 613, two groups on mating planes of the tray. Each AOC module in one group on one side (e.g., side 504) is optically connected with optical fibers to two AOC modules on the opposite side (e.g., 505)—e.g., to one AOC module in the group directly across the tray on the opposite side, and to a second AOC in the far group on the opposite side. More specifically, referring to FIG. 6, AOC module 620 of group 610 on side 504 is connected to two AOC modules on the opposite side 505 via optical fibers 640. The first is AOC module 621 of group 611. This module is directly across from AOC module 620. The second is AOC module 622 of group 612 on the far side of the opposite side 505. While such an interconnection configuration is conventional for commercially available midplane connection systems for interconnecting switch and line cards, it should be understood that the interconnection of the AOC modules can be varied according to the interconnection requirements of the application. For example, because the system provides for separable fiber interfaces across rows and columns in one embodiment, the fibers may be configured to connect multiple AOCs in a full matrix, in which all modules on side 602 are connected to all other modules on mating plane 603.

Referring to FIG. 7, the optical fibers in the mid-plane connector system have been removed revealing a circuit board 701 interconnecting the various AOC modules. In this embodiment, the circuit board 701 facilitates the lower speed control signals and power supply for the AOC modules. To this end, connectors 702 are also attached to the circuit board 701 to interface with a control and power signals, and an AOC controller 703 is disposed on the circuit board 701 to control the signals. In one embodiment, when multiple trays are stacked, connectors 702 are aligned allowing a jumper card to be used to interconnect the connectors 702. Thus, in the embodiment of FIG. 7, the tray has two platforms for transmitting signals and power. The first platform includes the optical fibers 640 interconnecting the AOC modules to transmit payload signals at high speed as shown in FIG. 6, and the second platform includes the circuit board 701, controller 703 and interconnections between the board 701 and the AOC modules to transmit power and control signals at a relatively lower speed since power and control signal typically do not need to be transmitted at the speed of the payload signals. Such a configuration streamlines the high-speed platform for enhanced performance. It should be understood, however, that other configurations are possible, including, for example, a combined platform of control and payload signals with a separate platform for power.

In one embodiment, multiple cable trays 501 as shown in FIG. 5 can be assembled to a form mid-plane assembly 801 as shown in FIG. 8. In this embodiment, four cable trays 501 are incorporated into a mid-plane assembly 801. When assembled, the modules 100 form rows 810 and columns 811 of electrical connectors to facilitate the horizontal and vertical mating of cards as described below. It should be understood that, although a midplane assembly is described herein in detail, the module and trays of the preset invention are not limited to such embodiments, and can be used in any configuration involving one or more mating planes for cards.

The mid-plane assembly 801 is part of a larger cable system 850. The system 850 comprises a plurality of line cards 851 are configured for a connection to the mating plane on one side 804 of the cable mid-plane assembly 801, while a set of full or half rack switch cards 852 are configured for connection to the mating plane of the other side 805 of the cable mid-plane system. In this particular embodiment, the line cards 851 are configured to mate with a row of connectors, while the switch cards 852 are configured to mate with a columns of connectors. Such configurations are well-known and other variations are within the scope of the invention in light of this disclosure.

It should be understood that the foregoing is illustrative and not limiting and that obvious modifications may be made by those skilled in the art without departing from the spirit of the invention. Accordingly, the specification is intended to cover such alternatives, modifications, and equivalence as may be included within the spirit and scope of the invention as defined in the following claims.

What is claimed is:

1. A module having first and second ends, and comprising:
at least one circuit board extending from said first end to said second end;
at least one electrical connector at said first end, said at least one electrical connector being electrically connected to said circuit board, said electrical connector having a form factor of a standard electrical connector;
at least one optical connector at said second end;
a plurality of optical electrical devices (OEDs) disposed on said circuit board, wherein said OEDs are connected electrically to said at least one electrical connector through said circuit board, and wherein said OEDs are connected optically to at least one said optical connector.

2. The module of claim 1, wherein said at least one electrical connector comprises a plurality of electrical conductors, and wherein said at least one optical connector comprises a plurality of optical conductors.

3. The module of claim 1, wherein said plurality of electrical conductors defines a first face and said plurality of optical conductors defines a second face, said first and second faces being parallel.

4. The module of claim 1, wherein said at least on circuit board comprises first and second circuit boards.

5. The module of claim 1, wherein said first and second circuit boards are parallel to each other and perpendicular to said first and second faces.

6. The module of claim 1, wherein said standard form factor connector is configured to connect with at least one circuit board.

7. The module of claim 1, wherein said standard form factor connector is a STRADA Whisper Connector System, double sided R/A receptacle.

8. The module of claim 1, wherein said module has at least a first and second side, said first circuit board having a first outer surface and a first inner surface, said first outer surface facing said first side, at least a first portion of said OEDs being mounted on said first outer surface, said at least a portion of said OEDs being connected optically to at least a portion of said optical connectors from said first inner surface, said second circuit board having a second outer surface and a second inner surface, said second outer surface facing said second side, at least a second portion of said OEDs being mounted on said second outer surface, said at least a portion of said OEDs being connected optically to at least a portion of said optical connectors from said second inner surface.

9. The module of claim 1, further comprising fibers optically connecting said at least a portion of said OEDs to said at least a portion of said optical connectors.

10. The module of claim 1, wherein said first and second circuit boards are parallel.

11. The module of claim 1, wherein said first and second inner surfaces are facing each other.

12. The module of claim 1, further comprising a housing, said housing comprising a heat conducting material, said housing being in thermal communication with at least a portion of said OEDs.

13. A cable tray comprising:
a tray having at least one mating plane;
a plurality of modules arranged along said mating plane, each module having first and second ends, and comprising:
at least one circuit board extending from said first end to said second end;
at least one electrical connector at said first end, at least one electrical connector being electrically connected to said circuit board, said electrical connector having a form factor of a standard electrical connector;
at least one optical connector at said second end;
a plurality of optical electrical devices (OEDs) disposed on said circuit board, wherein said OEDs are connected electrically to said at least one electrical connector through said circuit board, and wherein said OEDs are connected optically to at least one said optical connector; and
optical fibers, each fiber terminated at both ends with first and second optical connectors, said first optical connector connected to said at least one optical connector of a first module of said plurality of modules, and said second optical connector connected to said at least one optical connector of a second module of said plurality of modules.

14. The cable tray of claim 13, wherein said at least one electrical connector of said plurality of modules is disposed on said mating plane.

15. The cable tray of claim 13, wherein said at least one mating plane comprises at least first and second mating planes.

16. The cable tray of claim 15, wherein said first and second mating planes are on opposite side of said tray.

17. The cable tray of claim 15, wherein said first and second mating planes are orthogonal.

18. The cable tray of claim 15, wherein said first module is on said first mating plane, and said second module is on said second mating plane.

19. The cable tray of claim 18, wherein said optical fibers interconnect a module of said plurality of modules on said first mating plane with at least two modules of said plurality of modules on said second mating plane.

20. The cable tray of claim 19, wherein a plurality of modules are arranged in four groups, first and second groups on said first mating plane, and third and fourth groups on said second mating plane, wherein a module of said plurality of modules in said first group is connected to a module of said plurality of modules in said third group and to a module of said plurality of modules in said fourth group.

21. The cable tray of claim 13, wherein said optical fibers interconnect a module of said plurality of modules with at least another module of said plurality of modules.

22. The cable tray of claim 21, wherein said optical fibers interconnect a module of said plurality of modules with the other modules of said plurality of modules.

23. A cable system comprising:
a plurality of trays, each tray having at least one mating plane and comprising at least:
a plurality of modules arranged along said first mating plane, each module having a first and second end, and comprising at least:
at least one circuit board extending from said first end to said second end;
at least one electrical connector at said first end, said at least one electrical connector being electrically connected to said circuit board, said electrical connector having a form factor of a standard electrical connector;
at least one optical connector at said second end;
a plurality of optical electrical devices (OEDs) disposed on said circuit board, wherein said OEDs are connected electrically to said at least one electrical connector through said circuit board, and wherein said OEDs are connected optically to at least one said optical connector; and
optical fibers, each fiber terminated at both ends with first and second optical connectors, said first optical connector connected to said at least one optical connector of a first module of said plurality of modules, and said second optical connector connected to said at least one optical connector of a second module of said plurality of modules on said second mating plane.

24. The cable system of claim 23, wherein said at least one mating plane comprises at least first and second mating planes.

25. The cable system of claim 24, wherein said first module is on said first mating plane, and said second module is on said second mating plane.

26. The cable system of claim 25, wherein said trays are aligned to position said modules to form rows and columns of the electrical connectors.

27. The midplane connector assembly of claim 26, further comprising at least one line card connected to one of said rows of said electrical connectors, and a switch card connected to one of said columns of said electrical connectors.
